(19) United States
(12) Patent Application Publication
(10) Pub. No.: US 2026/0023840 A1
(43) Pub. Date: Jan. 22, 2026

(54) ELECTRONIC DEVICE FOR AUTHENTICATION USING VIRTUAL MACHINE AND OPERATION METHOD THEREOF

(71) Applicant: Samsung Electronics Co., Ltd., Suwon-si (KR)

(72) Inventor: Sangwoo LEE, Suwon-si (KR)

(21) Appl. No.: 19/339,980

(22) Filed: Sep. 25, 2025

Related U.S. Application Data
(63) Continuation of application No. PCT/KR2024/095641, filed on Mar. 28, 2024.

(30) Foreign Application Priority Data
Mar. 29, 2023 (KR) 10-2023-0041021
Apr. 24, 2023 (KR) 10-2023-0053412

(51) Int. Cl. G06F 21/44; G06F 21/62

(52) U.S. Cl. CPC G06F 21/44; G06F 21/6209

(57) ABSTRACT

A method for authentication using a virtual machine by an electronic device is provided. The method includes identifying, in a first virtual machine in which a host operating system (OS) is implemented, a user input for an application or data requiring authentication, in response to the user input, setting, by the first virtual machine through a hypervisor, a control authority for the application or the data to a second virtual machine in which a guest operating system (OS) is implemented, and performing, based on control of the second virtual machine, an external authentication procedure for the application or the data, wherein the hypervisor is a platform for concurrently executing the host OS and the guest OS on the electronic device.

### CROSS-REFERENCE TO RELATED APPLICATION(S)

This application is a continuation application, claiming priority under 35 U.S.C. § 365 (c), of an International application No. PCT/KR2024/095641, filed on Mar. 28, 2024, which is based on and claims the benefit of a Korean patent application number 10-2023-0041021, filed on Mar. 29, 2023, in the Korean Intellectual Property Office, and of a Korean patent application number 10-2023-0053412, filed on Apr. 24, 2023, in the Korean Intellectual Property Office, the disclosure of each of which is incorporated by reference herein in its entirety.

### BACKGROUND

### 1. Field

The disclosure relates to a technology for performing authentication using a virtual machine in an electronic device.

### 2. Description of Related Art

Data requiring security is stored in the form of encrypted files in the electronic device, and the electronic device does not steal data without the user's password or biometric authentication even if there is malicious access to the data. For electronic device authentication, there is a technology through text message-based authentication or an Android application immediately before signing up or using a service. For example, to use a financial service, identity authentication technology through mobile one time password (OTP) is performed.

Meanwhile, when using file-specific encryption technology in which the encrypted file and the password are shared with the user, the password leaks to the outside during the transformer of the password, and data decrypted by the user is arbitrarily processed or distributed by the user, potentially exceeding the original author's control. For instance, when a confidential encrypted document is sent along with a password via text message or email, there is a possibility that the password is exposed to external parties, potentially resulting in the sender losing the password and being unable to view the encrypted document.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a technology for performing authentication using a virtual machine in an electronic device.

Additional aspects will be set forth in part in the description which follows and, in part, will be apparent from the description, or may be learned by practice of the presented embodiments.

In accordance with an aspect of the disclosure, a method for performing authentication using a virtual machine by an electronic device is provided. The method includes identifying, in a first virtual machine in which a host operating system (host OS) is implemented, a user input for an application or data requiring authentication, in response to the user input, setting, by the first virtual machine through a hypervisor, a control authority for the application or the data to a second virtual machine, and performing, based on control of the second virtual machine, an external authentication procedure for the application or the data, wherein the hypervisor is a platform for concurrently executing the host OS and the guest OS on the electronic device.

In accordance with another aspect of the disclosure, an electronic device for performing authentication using a virtual machine is provided. The electronic device includes a communication circuit, memory, comprising one or more storage media, storing instruction, and at least one processor communicatively coupled to the communication circuit and the memory, wherein the instructions, when executed by the at least one processor individually or collectively, cause the electronic device to identify a user input, in a first virtual machine in which a host operating system (host OS) is implemented, a user input for an application or data requiring authentication, in response to the user input, set, through a hypervisor, a control authority for the application or the data to a second virtual machine in which a guest operating system (guest OS) is implemented and perform, based on control of the second virtual machine, an external authentication procedure for the application or the data, wherein the hypervisor is a platform for concurrently executing the host OS and the guest OS on the electronic device.

In accordance with another aspect of the disclosure, a non-transitory storage medium storing at least one computer-readable instruction that, when executed by at least one processor of an electronic device individually or collectively, cause the electronic device to perform a plurality of operations is provided. The plurality of operations includes identifying, in a first virtual machine in which a host operating system (host OS) is implemented, a user input for an application or data requiring authentication, in response to the user input, setting, by the first virtual machine through a hypervisor, a control authority for the application or the data to a second virtual machine in which a guest operating system (guest OS) is implemented, and performing, based on control of the second virtual machine, an external authentication procedure for the application or the data, wherein the hypervisor is a platform for concurrently executing the host OS and the guest OS on the electronic device.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating an electronic device in a network environment according to an embodiment of the disclosure;

FIG. 2 is a block diagram illustrating an example of a program according to an embodiment of the disclosure;

FIG. 3 is a view illustrating operations of an electronic device according to an embodiment of the disclosure of the disclosure;

FIG. 4 is a view illustrating an operation of an electronic device when accessing encrypted data according to an embodiment of the disclosure;

FIG. 5 is a view illustrating an operation in a system including an electronic device when accessing encrypted data according to an embodiment of the disclosure;

FIG. 6 is a view illustrating communication between a data owner and an authentication server according to an embodiment of the disclosure;

FIG. 7 is a view illustrating an operation of an electronic device when an external authentication application is executed according to an embodiment of the disclosure;

FIG. 8 is a view illustrating an operation in a system including an electronic device when an external authentication application is executed according to an embodiment of the disclosure; and

FIG. 9 is a view illustrating an operation of an electronic device according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

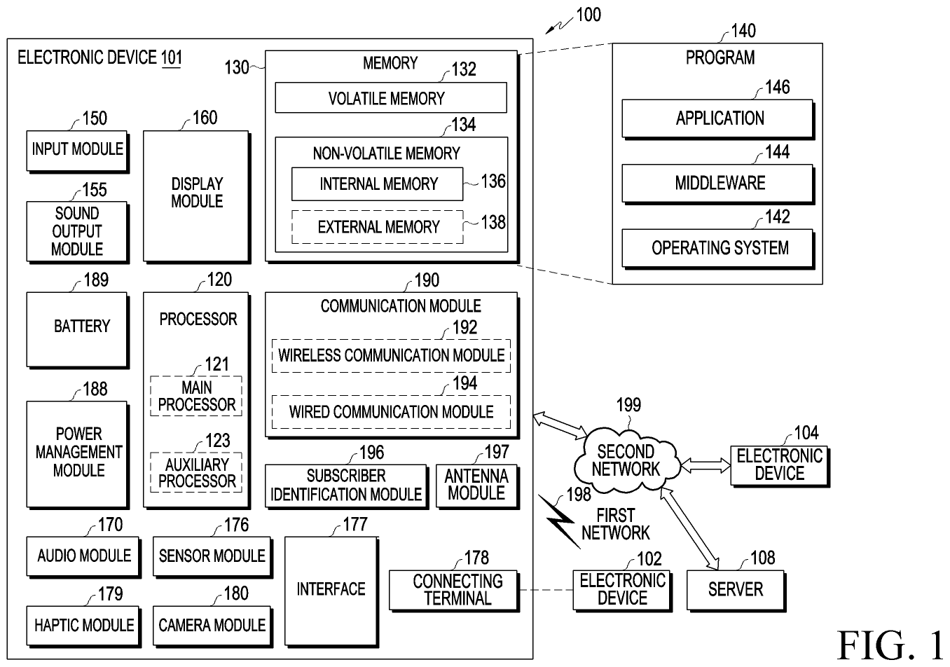

FIG. 1 is a block diagram illustrating an electronic device in a network environment according to an embodiment of the disclosure.

Referring to FIG. 1, the electronic device 101 in the network environment 100 may communicate with at least one of an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In an embodiment, at least one (e.g., the connecting terminal 178) of the components may be omitted from the electronic device 101, or one or more other components may be added in the electronic device 101. According to an embodiment, some (e.g., the sensor module 176, the camera module 180, or the antenna module 197) of the components may be integrated into a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be configured to use lower power than the main processor 121 or to be specified for a designated function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display 160 may include, for example, a display, a hologram device, or a projector and control circuitry to control a corresponding one of the display, hologram device, and projector. According to an embodiment, the display 160 may include a touch sensor configured to detect a touch, or a pressure sensor configured to measure the intensity of a force generated by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operation state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via a first network 198 (e.g., a short-range communication network, such as Bluetooth™, wireless-fidelity (Wi-Fi) direct, or infrared data association (IrDA)) or a second network 199 (e.g., a long-range communication network, such as a legacy cellular network, a fifth generation (5G) network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or user plane (U-plane) latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device). According to an embodiment, the antenna module 197 may include one antenna including a radiator formed of a conductor or conductive pattern formed on a substrate (e.g., a printed circuit board (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

According to an embodiment, the antenna module 197 may form a mmWave antenna module. According to an embodiment, the mm Wave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, instructions or data may be transmitted or received between the electronic device 101 and the external electronic device 104 via the server 108 coupled with the second network 199. The external electronic devices 102 or 104 each may be a device of the same or a different type from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to an embodiment of the disclosure may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

An embodiment of the disclosure may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The storage medium readable by the machine may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smartphones) directly. If distributed online, at least part of the computer program product may be temporarily generated or at least temporarily stored in the machine-readable storage medium, such as memory of the manufacturer's server, a server of the application store, or a relay server.

According to an embodiment, each component (e.g., a module or a program) of the above-described components may include a single entity or multiple entities. Some of the plurality of entities may be separately disposed in different components. According to an embodiment, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

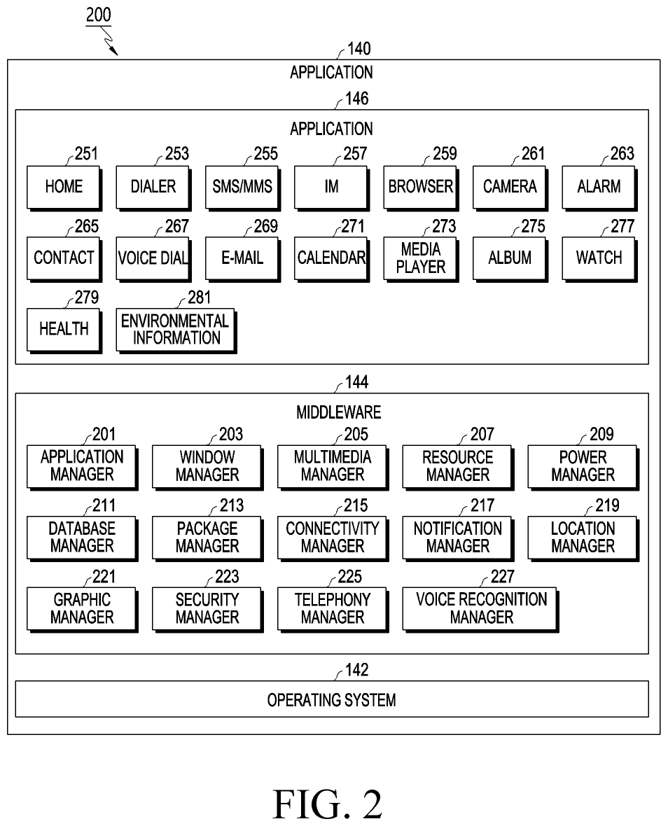

FIG. 2 is a block diagram 200 illustrating the program 140 according to an embodiment of the disclosure.

Referring to FIG. 2, according to an embodiment, the program 140 may include an operating system (OS) 142 to control one or more resources of the electronic device 101, middleware 144, or an application 146 executable in the OS 142. The OS 142 may include, for example, Android™, iOS™, Windows™, Symbian™, Tizen™, or Bada™. At least part of the program 140, for example, may be pre-loaded on the electronic device 101 during manufacture, or may be downloaded from or updated by an external electronic device (e.g., the electronic device 102 or 104, or the server 108) during use by a user.

The OS 142 may control management (e.g., allocating or deallocation) of one or more system resources (e.g., process, memory, or power source) of the electronic device 101. The OS 142, additionally or alternatively, may include one or more driver programs to drive other hardware devices of the electronic device 101, for example, the input module 150, the sound output module 155, the display module 160, the audio module 170, the sensor module 176, the interface 177, the haptic module 179, the camera module 180, the power management module 188, the battery 189, the communication module 190, the subscriber identification module 196, or the antenna module 197.

The middleware 144 may provide various functions to the application 146 such that a function or information provided from one or more resources of the electronic device 101 may be used by the application 146. The middleware 144 may include, for example, an application manager 201, a window manager 203, a multimedia manager 205, a resource manager 207, a power manager 209, a database manager 211, a package manager 213, a connectivity manager 215, a notification manager 217, a location manager 219, a graphic manager 221, a security manager 223, a telephony manager 225, or a voice recognition manager 227.

The application manager 201, for example, may manage the life cycle of the application 146. The window manager 203, for example, may manage one or more graphical user interface (GUI) resources that are used on a screen. The multimedia manager 205, for example, may identify one or more formats to be used to play media files, and may encode or decode a corresponding one of the media files using a codec appropriate for a corresponding format selected from the one or more formats. The resource manager 207, for example, may manage the source code of the application 146 or memory space of the memory 130. The power manager 209, for example, may manage the capacity, temperature, or power of the battery 189, and determine or provide related information to be used for the operation of the electronic device 101 based at least in part on corresponding information of the capacity, temperature, or power of the battery 189. According to an embodiment, the power manager 209 may interwork with a basic input/output system (BIOS) (not shown) of the electronic device 101.

The database manager 211, for example, may generate, search, or change a database to be used by the application 146. The package manager 213, for example, may manage installation or update of an application that is distributed in the form of a package file. The connectivity manager 215, for example, may manage a wireless connection or a direct connection between the electronic device 101 and the external electronic device. The notification manager 217, for example, may provide a function to notify a user of an occurrence of a specified event (e.g., an incoming call, message, or alert). The location manager 219, for example, may manage locational information on the electronic device 101. The graphic manager 221, for example, may manage one or more graphic effects to be offered to a user or a user interface related to the one or more graphic effects.

The security manager 223, for example, may provide system security or user authentication. The telephony manager 225, for example, may manage a voice call function or a video call function provided by the electronic device 101. The voice recognition manager 227, for example, may transmit a user's voice data to the server 108, and receive, from the server 108, a command corresponding to a function to be executed on the electronic device 101 based at least in part on the voice data, or text data converted based at least in part on the voice data. According to an embodiment, the middleware 244 may dynamically delete some existing components or add new components. According to an embodiment, at least part of the middleware 144 may be included as part of the OS 142 or may be implemented as another software separate from the OS 142.

The application 146 may include, for example, a home 251, dialer 253, short message service (SMS)/multimedia messaging service (MMS) 255, instant message (IM) 257, browser 259, camera 261, alarm 263, contact 265, voice recognition 267, email 269, calendar 271, media player 273, album 275, watch 277, health 279 (e.g., for measuring the degree of workout or biometric information, such as blood sugar), or environmental information 281 (e.g., for measuring air pressure, humidity, or temperature information) application. According to an embodiment, the application 146 may further include an information exchanging application (not shown) that is capable of supporting information exchange between the electronic device 101 and the external electronic device. The information exchange application, for example, may include a notification relay application adapted to transfer designated information (e.g., a call, message, or alert) to the external electronic device or a device management application adapted to manage the external electronic device. The notification relay application may transfer notification information corresponding to an occurrence of a specified event (e.g., receipt of an email) at another application (e.g., the email application 269) of the electronic device 101 to the external electronic device. Additionally or alternatively, the notification relay application may receive notification information from the external electronic device and provide the notification information to a user of the electronic device 101.

The device management application may control the power (e.g., turn-on or turn-off) or the function (e.g., brightness, resolution, or focus) of the external electronic device or some component thereof (e.g., a display module or a camera module of the external electronic device). The device management application, additionally or alternatively, may support installation, delete, or update of an application running on the external electronic device.

The disclosure proposes a technology related to a hypervisor-based virtual machine, a framework associated with the virtual machine, and/or an interface associated with the virtual machine among the software layers of an electronic device (or a mobile device).

The hypervisor may mean a platform for concurrently executing a plurality of operating systems in an electronic device (e.g., a host device). The hypervisor may be implemented in software, hardware, and/or a combination of software and hardware. The hypervisor may be a solution for managing a virtual machine. The hypervisor may also be referred to as a virtual machine monitor or a virtual machine manager.

The virtual machine is a piece of software that implements a computing environment as software, and may mean software that emulates (virtualizes) a computer system. An operating system and/or application may be installed and/or executed on the virtual machine.

The electronic device may use at least one virtual machine through the hypervisor. The hypervisor may support a plurality of operating systems in one electronic device, and has more rights than each operating system, thereby allocating and managing resources of the CPU, and/or memory to each operating system. In principle, each of the virtual machines in the electronic device is strictly separated from each other not to be cross-referenced, but for the effective implementation of the functions in each virtual machine, a shared memory area may be implemented by the hypervisor or communication between virtual machines may be performed as necessary.

When input/output through a secure screen distinguished from a general input/output path is required in the electronic device, a trusted user interface (UI) technology may be used. When an input/output path and/or buffer associated with the UI is present in a default operating system or host virtual machine, which is a non-secure area, the security level required by the electronic device may not be obtained.

In the electronic device, the trusted UI uses a separate path distinguished from the general input/output path, and the related buffer is also positioned in a different area distinguished from the default operating system or the host virtual machine, so that the security level required by the electronic device may be obtained. According to an embodiment, a trusted UI may be implemented through a secure mode supported by an application processor (AP) or a strictly separated virtual machine.

According to an embodiment, after obtaining real-time approval from the data owner for the data encrypted by an external electronic device (or other user) or an external server, the electronic device may decrypt the encrypted data and use the encrypted data only at an allowed time without risk of information leakage. According to an embodiment, the electronic device may perform authentication on an external manager for the execution of a specific application, and restrict and monitor the use of the application by the user (e.g., a minor) who does not have appropriate authority. In the disclosure, the data owner may be implemented as an external electronic device (e.g., the electronic device 102 of FIG. 1) and/or an external server (e.g., the server 108 of FIG. 1). According to an embodiment, the data owner may also be referred to as a data sharer or a data provider.

According to an embodiment, the electronic device may decrypt data and/or execute a specific application when authentication of the data owner or application manager performed based on the data user's identity (ID), the agreement or contractual relationship made when sharing data between the data owner and the data user, and/or environment information about the electronic device is successful. According to an embodiment, the electronic device may use decrypted data and/or execute a specific application in a specific virtual machine to maintain a security level for the corresponding data and/or application and manage the life cycle of the corresponding data and/or application.

According to an embodiment, the electronic device may implement security functions that require a space independent from the host operating system (host OS), such as biometric authentication and encryption, that may be implemented in a trusted application, as the virtual machine.

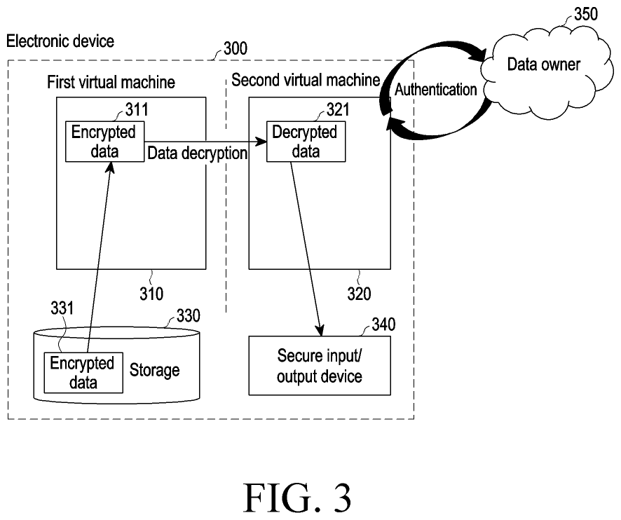

FIG. 3 is a view illustrating operations of an electronic device according to an embodiment of the disclosure.

Referring to FIG. 3, the electronic device 300 may include a first virtual machine 310, a second virtual machine 320, storage 330, and a secure input/output device 340. The electronic device 300 may include at least a portion of the electronic device 101 of FIG. 1. The first virtual machine 310 may be implemented as a host virtual machine (VM) for a host operating system, and the second virtual machine 320 may be implemented as a guest VM for secure data. The host operating system and at least one application may be implemented in the first virtual machine 310. The guest operating system and at least one application may be implemented in the second virtual machine 320. At least one processor (e.g., the processor 120 of FIG. 1) in the electronic device 300 may execute the first virtual machine 310 and/or the second virtual machine 320. The storage 330 may include at least a portion of the memory 130 of FIG. 1.

The electronic device 300 may move the encrypted data 331 included in the storage 330 into the first virtual machine 310 and identify and/or store the encrypted data 311 in the first virtual machine 310. According to an embodiment, the encrypted data 311 may be the same as or at least partially different from the encrypted data 331 in the storage 330. The electronic device 300 may communicate with the data owner 350 using the second virtual machine 320 and perform an authentication procedure.

According to an embodiment, the data owner 350 may be implemented as an external electronic device (e.g., the electronic device 102 of FIG. 1) that is the owner of the encrypted data 311. According to an embodiment, the data owner 350 may be implemented as an external server (e.g., the server 108 of FIG. 1) that is the owner of the encrypted data 311.

The electronic device 300 may perform data decryption on the encrypted data 311 after completion of authentication through communication with the data owner 350. According to an embodiment, the first virtual machine 310 may request the second virtual machine 320 to decrypt the encrypted data 311. Based on the request, the second virtual machine 320 may decrypt the encrypted data 311 and generate and/or obtain the decrypted data 321 according to the performance result. The electronic device 300 may identify and/or store the decrypted data 321 in the second virtual machine 320. The electronic device 300 may output and/or display the decrypted data 321 through the secure input/output device 340. For example, the electronic device 300 may apply a trusted user interface (UI) function to the data 321 decrypted through the secure input/output device 340.

The data owner 350 may be a data owner or server that receives an authentication request and notifies of an authentication success or authentication failure. According to an embodiment, when the data owner 350 is an electronic device, an application capable of processing the corresponding authentication may be installed to process a real-time authentication request. According to an embodiment, when the data owner 350 is a server, a server application that performs network communication corresponding to the authentication request may process the request.

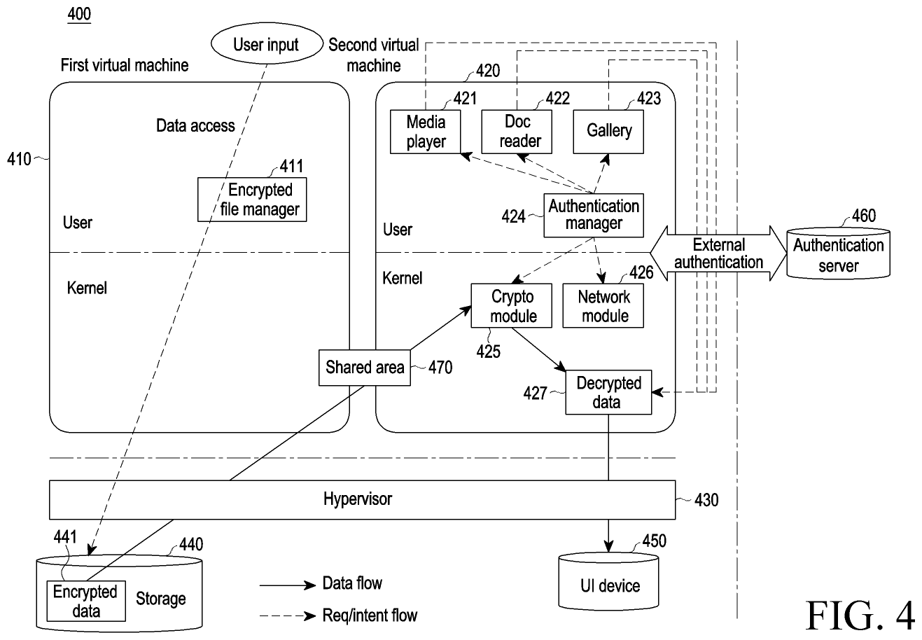

FIG. 4 is a view illustrating an operation of an electronic device when accessing encrypted data according to an embodiment of the disclosure.

Referring to FIG. 4, the electronic device 400 may include a first virtual machine 410, a second virtual machine 420, a hypervisor 430, storage 440, and a UI device 450. The electronic device 400 may be implemented as the electronic device 101 of FIG. 1. The first virtual machine 410 may be implemented as a host virtual machine (VM) for a host operating system, and the second virtual machine 420 may be implemented as a guest VM for secure data. The host operating system and at least one application may be implemented in the first virtual machine 410. The guest operating system and at least one application may be implemented in the second virtual machine 420. Each of the first virtual machine 410 and the second virtual machine 420 may include a user portion and a kernel portion. At least one processor (e.g., the processor 120 of FIG. 1) in the electronic device 400 may execute the first virtual machine 410, the second virtual machine 420, and/or the hypervisor 430.

An encrypted file manager 411 may be implemented in the user portion of the first virtual machine 410. A media player 421, a DoC reader 422, a gallery 423, and an authentication manager 424 may be implemented in the user portion of the second virtual machine 420, and a crypto module 425 and a network module 426 may be implemented in the kernel portion of the second virtual machine 420. The first virtual machine 410 and the second virtual machine 420 do not directly communicate with each other, but may share data in the shared area 470 through the hypervisor 430. According to an embodiment, the shared area 470 may be implemented as at least one memory.

The electronic device 400 may move and/or store the encrypted data 441 included in the storage 440 via the hypervisor 430 to the shared area 470 in response to a user input through the first virtual machine 410.

The encrypted data 441 may be encrypted and implemented in units of data files by the data owner. A header is inserted in front of the encrypted portion of the encrypted data 441, and the header may include at least one of the size of the original file, an enumerator indicating the file type as a separator to be used in the authentication manager 424, an authenticator ID, the size of the header, and/or the name of the original file. According to an embodiment, the data owner should register a network address or an ID of an authentication application to receive an authentication request later in the authentication server 460, and may be assigned an authenticator ID as a result of the registration request. According to an embodiment, the encrypted file may have a specific extension.

The encrypted file manager 411 may be positioned in the framework of the user layer of the first virtual machine 410. When the user accesses the encrypted data 441 by the user input, the encrypted file manager 411 may load the encrypted data 441 into the shared area 470, and set and/or change the control authority (or control right) for the encrypted data 441 to the authentication manager 424 of the second virtual machine 420.

According to an embodiment, when the encrypted data 441 has a specific extension and accesses data having the extension in the operating system of the first virtual machine 410, the encrypted file manager 411 may be registered to be automatically performed. According to an embodiment, when the encrypted data 441 has a specific extension and accesses data having the extension in the operating system of the first virtual machine 410, the encrypted file manager 411 may be explicitly executed and the user may discover the encrypted data 441.

When access to the encrypted data 441 stored in the storage 440 is detected, the encrypted file manager 411 associated with the extension of the encrypted data 441 may operate on the platform of the first virtual machine 410. According to an embodiment, the electronic device 400 may explicitly execute the encrypted file manager 411 and search for the encrypted data 441 to be desired to be accessed in the absence of a platform association.

According to an embodiment, the data encryption may be performed using a key present in the owner's electronic device or server in a state in which a header including the type of file, the name of the original file including the extension, the size of the file, and the owner's ID is added to the original file. According to an embodiment, the encrypted data 441 may be transferred, with a specific extension, to at least one electronic device (or user) through a general file transfer path such as a messenger or an email.

The encrypted file manager 411 may load the encrypted data 441 into the shared area 470 through the hypervisor 430, and change the control authority for the encrypted data 441 to the authentication manager 424 of the second virtual machine 420. According to an embodiment, the control authority change operation may be performed by the hypervisor 430. According to an embodiment, the control authority change operation may be performed based on the hypervisor 430 operating in the electronic device 400 and a related kernel driver.

The authentication manager 424 may read the header of the encrypted data 441 in the shared area 470, recognize the area of the encrypted data 441, and calculate a hash for the area. The authentication manager 424 may identify who is to be requested for authentication of access to what data based on at least one of the authenticator ID, file type information, file size, and calculated hash values included in the header. The information included in the header may correspond to the characteristic format of the encrypted data file having the specific extension.

The authentication manager 424 may perform an external authentication procedure with the authentication server 460. The authentication server 460 may search for the registered data owner based on the authenticator ID and transfer the remaining values (e.g., at least one of file type information, file size, and calculated hash value) to the data owner. According to an embodiment, if data access occurs and control authority (or control right) is transferred to the authentication manager 424, it may be examined whether encrypted data suitable for the shared area 470 is loaded by identifying whether each of the internal values of the header is in a normal range. According to an embodiment, when the encrypted data is suitable, the authentication manager 424 may perform an external authentication request by transmitting the authenticator ID and information capable of indicating who the data user is to the authentication server 460.

According to an embodiment, account information activated in the electronic device 400 may be used to indicate who the data user is, and what type of account to use may be predesignated (or set) between the data user and the data owner. According to an embodiment, the data owner may determine whether to approve authentication using the transferred values (e.g., at least one of the file type information, file size, and calculated hash value).

According to an embodiment, what data file the request is for may be identified through the hash value calculated at the time of encryption for data sharing. According to an embodiment, what data file it is for, and who is the user are identified and, if the access is appropriate, the authentication server 460 may transformer the key used for encryption to the electronic device 400 (or data user). According to an embodiment, the real-time approval may be configured to be identified and processed by the data owner each time. According to an embodiment, the real-time approval may be configured on the data owner's electronic device or server to input a specific condition in advance and automatically give a response that meets the condition. These conditions may be determined based on the agreement or contractual relationship between the data owner and the data user in advance, such as whether the data user is included in a list with data access authority entered in advance by the data owner or whether the data owner is registered with a subscription service defined by the data owner.

In the case of authentication for a data file, the authentication manager 424 may calculate a hash value for the entire area of the encrypted data 441 and transfer it to the data owner in order to allow the data owner to know what data file is requested for authentication. According to an embodiment, when authentication of the data file is successful, data decryption may be performed in the second virtual machine 420 using the key transferred from the data owner together with the authentication result. After the decryption is completed, the key may be deleted immediately. According to an embodiment, the second virtual machine 420 may read usage time information transferred along with the success in authentication for the data file and control not to receive additional approval for access to the same data file during the corresponding time.

When external approval is successful, the authentication manager 424 may decrypt the encrypted data positioned in the shared area 470 using the received key. If the decryption is completed, the transferred key may be deleted.

The decrypted data 427 is present inside the second virtual machine 420 for security, and may be identified only through a secure input/output path (e.g., a path of a trusted UI). According to an embodiment, the electronic device 400 may execute an application suitable for the type of data to view the secure data. According to an embodiment, the data to be used may be limited to media data such as photos, music, and images and documents.

The policy for processing after use of the decrypted data 427 may be transferred at the time of authentication of the data owner. Here, the policy may include the time when the decrypted data 427 may be used and/or the number of uses. For example, certain secure documents may be implemented to be accessed up to three times without additional authentication after the authentication of the owner of the document, or to allow repeated access for one hour after the initial authentication.

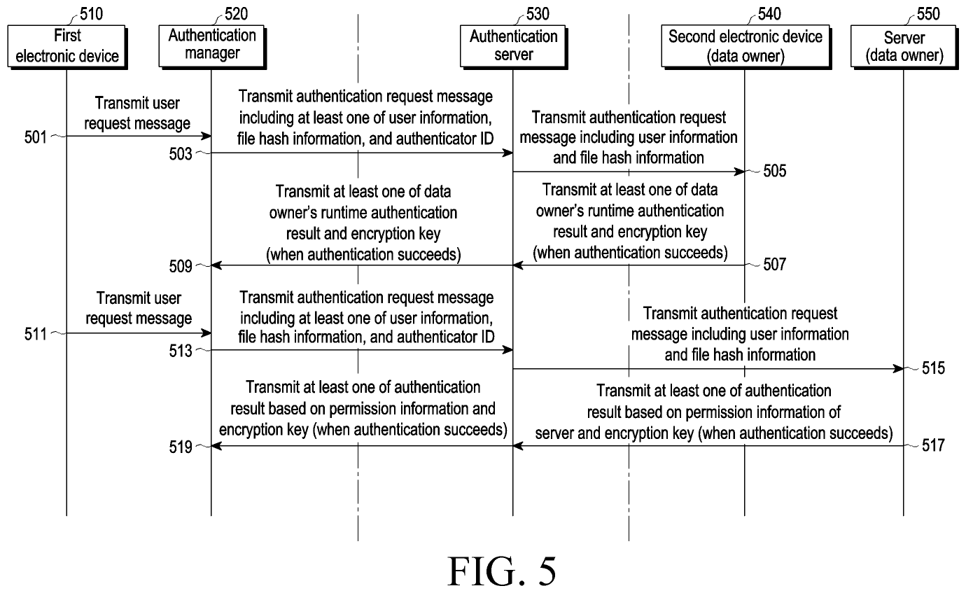

FIG. 5 is a view illustrating an operation in a system including an electronic device when accessing encrypted data according to an embodiment of the disclosure.

Referring to FIG. 5, the system may include at least one of a first electronic device 510, an authentication manager 520, an authentication server 530, a second electronic device (data owner) 540, and a server (data owner) 550.

According to an embodiment, the data owner of the encrypted data accessed by the user may be the second electronic device (data owner) 540. In this case, in operation 501, the first electronic device 510 may transmit a user request message to the authentication manager 520. In operation 503, the authentication manager 520 may transmit an authentication request message including at least one of user information, file hash information, and an authenticator ID to the authentication server 530. According to an embodiment, for effective authentication, the authentication request message may be configured to include all of the user information, the file hash information, and the authenticator ID. In operation 505, the authentication server 530 may transmit an authentication request message including user information and file hash information to the second electronic device (data owner) 540. In operation 507, the second electronic device (data owner) 540 may transmit at least one of a runtime authentication result of the data owner and an encryption key (when authentication is successful) to the authentication server 530. In operation 509, the authentication server 530 may transmit at least one of the data owner's runtime authentication result and an encryption key (when authentication is successful) to the authentication manager 520.

According to an embodiment, the data owner of encrypted data accessed by the user may be a server (data owner) 550. In this case, in operation 511, the first electronic device 510 may transmit a user request message to the authentication manager 520. In operation 513, the authentication manager 520 may transmit an authentication request message including at least one of user information, file hash information, and an authenticator ID to the authentication server 530. According to an embodiment, for effective authentication, the authentication request message may be configured to include all of the user information, the file hash information, and the authenticator ID. In operation 515, the authentication server 530 may transmit an authentication request message including user information and file hash information to the server (data owner) 550. In operation 517, the server 550 may transmit at least one of an authentication result based on permission information held by the server 550 and an encryption key (when authentication is successful) to the authentication server 530. In operation 519, the authentication server 530 may transmit at least one of an authentication result based on the permission information and the encryption key (when authentication is successful) to the authentication manager 520.

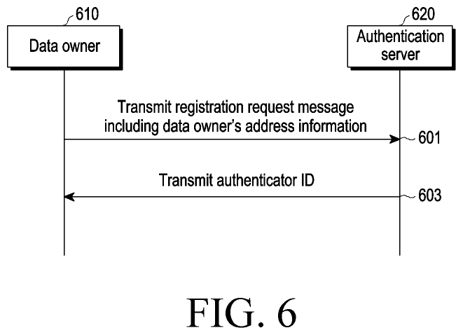

FIG. 6 is a view illustrating communication between a data owner and an authentication server according to an embodiment of the disclosure.

Referring to FIG. 6, in operation 601, the data owner 610 may transmit a registration request message including address information about the data owner 610 to the authentication server 620. According to an embodiment, the data owner 610 may be implemented as an electronic device (e.g., the external electronic device 102 or 104 of FIG. 1) or a server (e.g., the server 108 of FIG. 1). In operation 603, the authentication server 620 may transmit the authenticator ID to the data owner 610.

When generating an encrypted data file, the data owner 610 may communicate with the authentication server 620 to register its network address and receive the authenticator ID from the authentication server 620. This may be for the authentication server 620 to receive an authentication request from the data user and to know to which owner the corresponding request is to be transferred to. When an authentication request is received, it is necessary to know which data file the request is for, so that database management may be performed on its own by creating a hash value for each encrypted data file. According to an embodiment, the data owner 610 may transmit time information about how long the data may be used without additional authentication with the authentication along with the key used to encrypt the data file when notifying of the authentication success.

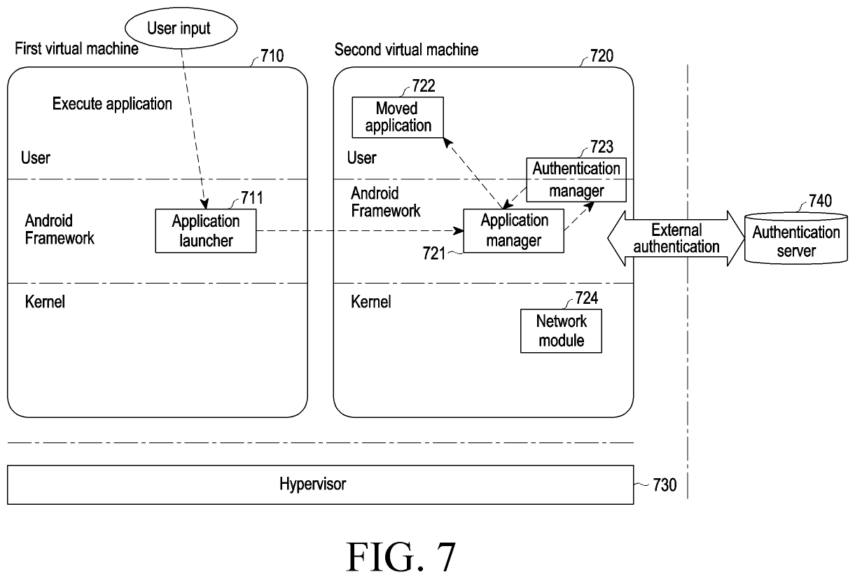

FIG. 7 is a view illustrating an operation of an electronic device when an external authentication application is executed according to an embodiment of the disclosure.

Referring to FIG. 7, the electronic device 700 may include a first virtual machine 710, a second virtual machine 720, and a hypervisor 730. The electronic device 700 may be implemented as the electronic device 101 of FIG. 1. The first virtual machine 710 may be implemented as a host virtual machine (VM) for a host operating system, and the second virtual machine 720 may be implemented as a guest VM for secure data. The host operating system and at least one application may be implemented in the first virtual machine 710. The guest operating system and at least one application may be implemented in the second virtual machine 720. Each of the first virtual machine 710 and the second virtual machine 720 may include a user portion, an Android framework portion, and a kernel portion.

The application launcher 711 implemented in the Android framework of the first virtual machine 710 may distinguish a general application from an external authentication-based application. According to an embodiment, if the application is transferred from the first virtual machine 710 to the second virtual machine 720 and installed, the access path to the files constituting the application in the first virtual machine 710 disappears, and thus it may be existing application.

When the external authentication-based application is executed, the application launcher 711 may hand over control authority to the application manager 721 operating in the Android framework of the second virtual machine 720, and the second virtual machine 720 may perform an external authentication procedure and/or application execution.

The second virtual machine 720 may perform a function of decrypting encrypted data, a function of independently executing an application, a communication function of transmitting and/or receiving authentication information with an information owner (e.g., an external electronic device or an external server), and/or a function of managing decrypted data as a secure input/output separated from hardware input/output of the first virtual machine 710. The second virtual machine 720 is separated on the stage2 page table so that other virtual machines do not refer to the memory area, and may implement and/or execute a hypervisor application only for the purpose of retrieving encrypted data from the first virtual machine 710.

An application 722 moved and installed in the user portion of the second virtual machine 720 may be implemented and/or executed. The network module 724 may be implemented in the kernel portion of the second virtual machine 720.

In order to move and install an external authentication-based application from the first virtual machine 710 to the second virtual machine 720, or to execute an external authentication-based application in the second virtual machine 720, the second virtual machine 720 may have the same framework or operating system as the first virtual machine 710. For example, if the first virtual machine 710 is Android, the second virtual machine 720 may be Android or an environment in which an Android application may be executed.

When encrypted data is accessed in the first virtual machine 710 or an external authentication application is executed, the authentication manager 723 may request authentication from the data owner or application manager on the second virtual machine 720. When accessing encrypted data, the authentication manager 723 may decrypt the encrypted data file and perform a task related to an application using secure input/output in the second virtual machine 720. According to an embodiment, the authentication manager 723 may identify and/or search for the authenticator ID input when the application is transferred and installed on the second virtual machine 720 when the application is executed. According to an embodiment, a dedicated storage space for the second virtual machine 720 may are present.

According to an embodiment, information indicating the data user (e.g., account information) is a value transferred to the data owner as it is from the authentication server 740 and may be agreed in advance between the data owner and the data user.

According to an embodiment, a flag indicating the type of authentication indicating whether the authentication is for a data file, an application, execution of an application execution, or application deletion may be defined. According to an embodiment, the flag indicating the type of authentication may be implemented as a 1-byte flag.

The application manager 721 of the second virtual machine 720 performs the same or similar role as the application launcher 711 of the first virtual machine 710, but may operate differently from the application launcher 711 in that the authentication manager 723 is additionally executed to receive external authentication when the application is executed and deleted, and the application is managed with the application usage time received as a result of the external authentication. According to an embodiment, if the usage time transferred along with the external authentication success is exceeded, the use of the application may be possible only after authentication success is obtained again.

In the case of an external authentication application, the target of external authentication may be the execution of the application, not access to the encrypted data file. When the previously installed application is transferred to the second virtual machine 720 and the application is executed in the second virtual machine 720, the use of the application may be managed and/or supervised from the outside by allowing it to receive external authentication all the time.

The previously installed external authentication-based application is present in the application list in the first virtual machine 710, but all of the files constituting the application may be present in the second virtual machine 720. If an application is executed in the first virtual machine 710, the application launcher 711 of the first virtual machine 710 hands the control right over to the application manager 721 of the second virtual machine 720, and as in the case of data, the movement of the control right or information between virtual machines may be performed in a predefined method based on the hypervisor 730 present in the electronic device 700.

The application manager 721 of the second virtual machine 720 may attempt external authentication by executing the authentication manager 723 before executing the application, and may determine whether to execute the application according to the result. In this case, the external authentication may be performed in the same manner as in the case of data.

According to an embodiment, the external authentication-based application may be configured to obtain external approval of the manager even when the user attempts to delete it because the manager is not needed when the user is free to delete it. According to an embodiment, the application manager 721 of the second virtual machine 720 may perform an authentication request through the authentication manager 723 as in the case of executing the application even when the application is deleted.

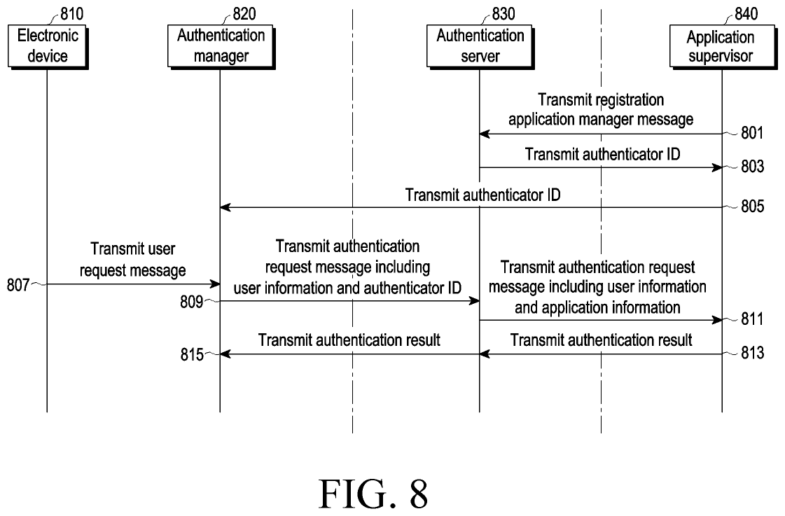

FIG. 8 is a view illustrating an operation in a system including an electronic device when an external authentication application is executed according to an embodiment of the disclosure.

Referring to FIG. 8, the system may include an electronic device 810, an authentication manager 820, an authentication server 830, and an application supervisor 840. The authentication manager 820 may be included and implemented in the electronic device 810. According to an embodiment, the authentication manager 820 may be implemented as an authentication manager (e.g., the authentication manager 723 of FIG. 7) positioned in the second virtual machine (e.g., 720 of FIG. 7) of the electronic device (e.g., the electronic device 700 of FIG. 7). The application supervisor 840 may manage an application and/or settings for the application. According to an embodiment, the application supervisor 840 may be implemented in an external electronic device (e.g., the electronic device 102 or the electronic device 104 of FIG. 1) or an external server (e.g., the server 108 of FIG. 1).

In operation 801, the application supervisor 840 may transmit a register application manager message to the authentication server 830. In operation 803, the authentication server 830 may transmit the authenticator ID to the application supervisor 840. In operation 805, the application supervisor 840 may transmit the authenticator ID to the authentication manager 820.

In operation 807, the electronic device 810 may transmit a user request message to the authentication manager 820. In operation 809, the authentication manager 820 may transmit an authentication request message including the user information and the authenticator ID to the authentication server 830. In operation 811, the authentication server 830 may transmit an authentication request message including user information and application information to the application supervisor 840.

In operation 813, the application supervisor 840 may transmit the authentication result to the authentication server 830. In operation 815, the authentication server 830 may transmit the authentication result to the authentication manager 820.

The application supervisor 840 may be an electronic device or server that receives an authentication request for an external authentication-based application to notify of an authentication success or an authentication failure. The application supervisor 840 should generate its own authenticator ID through a registration procedure to the authentication server 830, and may transfer the same to the application user to be transferred to the authentication server 830 along with the corresponding ID when the application requests external authentication. According to an embodiment, in the authentication procedure, as in the case of the data owner, a result value for authentication and information about the available time when authentication succeeds may be transmitted together. According to an embodiment, an application deletion operation of the user may also be possible when authentication of the application supervisor 840 is successful.

The application supervisor 840 may register its network address in the authentication server 830 and be allocated the authenticator ID. The application user may select an application to receive external authentication among general applications and transfer and install the same on the guest virtual machine. The authenticator ID received from the application supervisor 840 may be transferred to the guest virtual machine and stored therein to be referred to when the application launcher requests external authentication of the application. According to an embodiment, the authenticator ID transfer method may be variously implemented according to the established service logic.

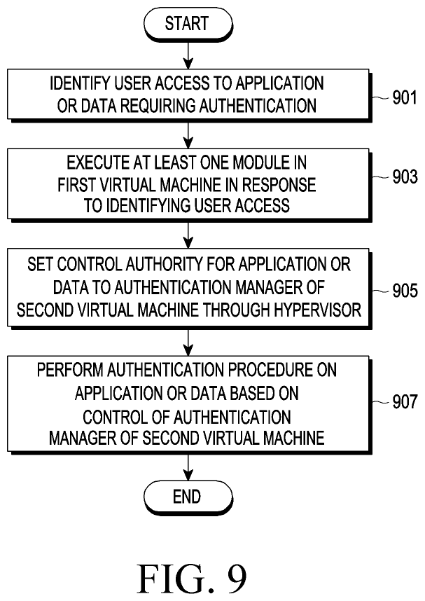

FIG. 9 is a view illustrating an operation of an electronic device according to an embodiment of the disclosure.

Referring to FIG. 9, in operation 901, the electronic device (or the processor 120 of FIG. 1) may identify user access to an application or data requiring authentication. In operation 903, the electronic device (or the processor 120 of FIG. 1) may execute at least one module (e.g., an application execution module and/or an encrypted file manager) in the first virtual machine in response to the identification of the user access. In operation 905, the electronic device (or the processor 120 of FIG. 1) may set the control authority for the application or the data to the authentication manager of the second virtual machine through the hypervisor. In operation 907, the electronic device (or the processor 120 of FIG. 1) may perform an authentication procedure for the application or the data based on the control of the authentication manager of the second virtual machine.

According to an embodiment, a method for operating an electronic device (or a processor (e.g., the processor 120 of FIG. 1)) performing authentication using a virtual machine may comprise identifying a user input, in a first virtual machine, for an application or data requiring authentication. The method for operating the electronic device (or a processor (e.g., the processor 120 of FIG. 1)) may comprise, in response to the user input, setting, by the first virtual machine through a hypervisor, a control authority for the application or the data to a second virtual machine. The method for operating the electronic device (or a processor (e.g., the processor 120 of FIG. 1)) may comprise performing, based on control of the second virtual machine, an external authentication procedure for the application or the data.

According to an embodiment, a host operating system and at least one application may be implemented in the first virtual machine. According to an embodiment, a guest operating system and at least one application may be implemented in the second virtual machine. According to an embodiment, the hypervisor may be a platform for concurrently executing a plurality of operating systems on the electronic device (or a processor (e.g., the processor 120 of FIG. 1)).

According to an embodiment, the method for operating the electronic device (or a processor (e.g., the processor 120 of FIG. 1)) may further comprise executing the application in the second virtual machine if the authentication for the application is completed.

According to an embodiment, the data requiring authentication may include at least one of an original file type, a file name including an extension, a file size, and an authenticator ID.

According to an embodiment, the method for operating the electronic device (or a processor (e.g., the processor 120 of FIG. 1)) may further comprise transmitting, under control of an authentication manager included in the second virtual machine, authentication request information for the application or the data to an external server. According to an embodiment, in the method for operating the electronic device (or a processor (e.g., the processor 120 of FIG. 1)), the authentication request information may include at least one of an authenticator ID, file type information, a file size, and a calculated hash value.

According to an embodiment, the method for operating the electronic device (or a processor (e.g., the processor 120 of FIG. 1)) may comprise transmitting, based on control of an authentication manager included in the second virtual machine, authentication request information for the application or the data to an external electronic device. According to an embodiment, whether the data is approved based on the authentication request information may be determined by a data owner. According to an embodiment, whether the application is approved based on the authentication request information may be determined by an application supervisor. According to an embodiment, if the authentication server receives a registration request message, the authenticator ID may be issued by the authentication server.

According to an embodiment, an electronic device (or a processor (e.g., the processor 120 of FIG. 1)) performing authentication using a virtual machine may comprise a communication circuit and at least one processor (120 of FIG. 1) connected to the communication circuit. The at least one processor may identify a user input, in a first virtual machine, for an application or data requiring authentication. The at least one processor may, in response to the user input, set, through a hypervisor, a control authority for the application or the data to a second virtual machine. The at least one processor may perform, based on control of the second virtual machine, an external authentication procedure for the application or the data.

According to an embodiment, in a storage medium storing at least one computer-readable instruction, the at least one instruction may, when executed by at least one processor, cause the electronic device to perform a plurality of operations. The plurality of operations may comprise identifying a user input, in a first virtual machine, for an application or data requiring authentication. The plurality of operations may comprise, in response to the user input, setting, by the first virtual machine through a hypervisor, a control authority for the application or the data to a second virtual machine. The plurality of operations may comprise performing, based on control of the second virtual machine, an external authentication procedure for the application or the data.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method for performing authentication using a virtual machine by an electronic device, the method comprising:
identifying, in a first virtual machine in which a host operating system (host OS) is implemented, a user input for an application or data requiring authentication;
in response to the user input, setting, by the first virtual machine through a hypervisor, a control authority for the application or the data to a second virtual machine in which a guest operating system (guest OS) is implemented; and
performing, based on control of the second virtual machine, an external authentication procedure for the application or the data,
wherein the hypervisor is a platform for concurrently executing the host OS and the guest OS on the electronic device.

2. The method of claim 1,
wherein at least one application is executed based on the host OS in the first virtual machine, and
wherein at least one application is executed based on the guest OS in the second virtual machine.

3. The method of claim 1, further comprising:
executing the application in the second virtual machine based on the authentication for the application being completed.

4. The method of claim 1, wherein the data requiring authentication includes at least one of an original file type, a file name including an extension, a file size, or an authenticator identity (ID).

5. The method of claim 1, further comprising:
transmitting, under control of an authentication manager included in the second virtual machine, authentication request information for the application or the data to an external server,
wherein the authentication request information includes at least one of an authenticator identity (ID), file type information, a file size, or a calculated hash value.

6. The method of claim 5,
wherein whether the data is approved based on the authentication request information is determined by an external electronic device, and
wherein whether the application is approved based on the authentication request information is determined by an application supervisor.

7. An electronic device for performing authentication using a virtual machine, the electronic device comprising:
a communication circuit;
memory, comprising one or more storage media, storing instructions; and
at least one processor communicatively coupled to the communication circuit and the memory,
wherein the instructions, when executed by the at least one processor individually or collectively, cause the electronic device to:
identify, in a first virtual machine in which a host operating system (host OS) is implemented, a user input for an application or data requiring authentication,
in response to the user input, set, through a hypervisor, a control authority for the application or the data to a second virtual machine in which a guest operating system (guest OS) is implemented, and
perform, based on control of the second virtual machine, an external authentication procedure for the application or the data, and
wherein the hypervisor is a platform for concurrently executing the host OS and the guest OS on the electronic device.

8. The electronic device of claim 7,
wherein at least one application is executed based on the host OS in the first virtual machine, and
wherein at least one application is executed based on the guest OS in the second virtual machine.

9. The electronic device of claim 7, wherein the instructions, when executed by the at least one processor individually or collectively, further cause the electronic device to:
execute the application in the second virtual machine based on the authentication for the application being completed.

10. The electronic device of claim 7, wherein the data requiring authentication includes at least one of an original file type, a file name including an extension, a file size, or an authenticator identity (ID).

11. The electronic device of claim 7, wherein the instructions, when executed by the at least one processor individually or collectively, further cause the electronic device to:
transmit authentication request information for the application or the data to an external server, and
wherein the authentication request information includes at least one of an authenticator identity (ID), file type information, a file size, or a calculated hash value.

12. The electronic device of claim 11,
wherein whether the data is approved based on the authentication request information is determined by an external electronic device, and
wherein whether the application is approved based on the authentication request information is determined by an application supervisor.

13. A non-transitory storage medium storing at least one computer-readable instruction that, when executed by at least one processor of an electronic device individually or collectively, cause the electronic device to perform a plurality of operations, the plurality of operations comprising:
identifying, in a first virtual machine in which a host operating system (host OS) is implemented, a user input for an application or data requiring authentication;
in response to the user input, setting, by the first virtual machine through a hypervisor, a control authority for the application or the data to a second virtual machine in which a guest operating system (guest OS) is implemented; and
performing, based on control of the second virtual machine, an external authentication procedure for the application or the data,
wherein the hypervisor is a platform for concurrently executing the host OS and the guest OS on the electronic device.

14. The non-transitory storage medium of claim 13,
wherein at least one application is executed based on the host OS in the first virtual machine, and
wherein at least one application is executed based on the guest OS in the second virtual machine.

15. The non-transitory storage medium of claim 13, wherein the plurality of operations further comprising:
executing the application in the second virtual machine if the authentication for the application is completed.

16. The non-transitory storage medium of claim 13, wherein the data requiring authentication includes at least one of an original file type, a file name including an extension, a file size, or an authenticator identity (ID).

17. The non-transitory storage medium of claim 13, wherein the plurality of operations further comprising:
transmitting, under control of an authentication manager included in the second virtual machine, authentication request information for the application or the data to an external server,
wherein the authentication request information includes at least one of an authenticator ID, file type information, a file size, or a calculated hash value.

18. The non-transitory storage medium of claim 17,
wherein whether the data is approved based on the authentication request information is determined by an external electronic device, and
wherein whether the application is approved based on the authentication request information is determined by an application supervisor.
